(19) United States
(12) Patent Application Publication
(10) Pub. No.: US 2016/0087470 A1
(43) Pub. Date: Mar. 24, 2016

(54) Wearable Mobile Phone Charging Apparatus

(71) Applicant: Christian M Lizama, Los Angeles, CA (US)

(72) Inventor: Christian M Lizama, Los Angeles, CA (US)

(21) Appl. No.: 14/859,014

(22) Filed: Sep. 18, 2015

Related U.S. Application Data
(60) Provisional application No. 62/052,044, filed on Sep. 18, 2014.

(51) Int. Cl. H02J 7/00; H02J 7/35

(52) U.S. Cl. CPC H02J 7/0045; H02J 7/0052; H02J 7/355; H02J 7/0047

(57) ABSTRACT

A wearable mobile phone charging apparatus contains a charging unit, a connectivity cable, and a casing. When worn around the neck, the charging unit acts as the medallion and the connectivity cable functions as the necklace portion. In another instance, when worn as a belt, the charging unit functions as the belt buckle. The charging unit consists of a rechargeable battery, a charging circuit, a set of charging prongs, a cable output port, and a cable input port. The set of charging prongs are utilized to charge the rechargeable battery through a power outlet. The cable input port and the cable output port are utilized along with the connectivity cable to transfer charge to and from the rechargeable battery. Additionally, a solar panel can also be used to charge the rechargeable battery.

The current application claims a priority to the U.S. Provisional Patent application Ser. No. 62/052,044 filed on Sep. 18, 2014.

### FIELD OF THE INVENTION

The present invention relates generally to a mobile phone charging apparatus. More specifically, the present invention introduces a wearable charging apparatus.

### BACKGROUND OF THE INVENTION

Mobile phones play a major role in our daily lives. In addition to being used for communication purposes, mobile phones are also used during travelling, business, and other related activities. For continuous use, the mobile phones need to be regularly charged. As experienced by many, not having sufficient power can lead to stressful situations. In order to address the issue, many users constantly carry the mobile phone charger. This can be either a wall mount charger, a car charger, or a universal serial bus (USB) cable charger. Even though carrying these chargers is extremely beneficial, they could also have certain drawbacks.

One major disadvantage is that most of the existing mobile phone chargers, especially wall mount chargers, are bulky and require a considerable amount of space. The need for space is especially disadvantageous if the user intends on travelling light. As an example, if the user plans on engaging in outdoor activities, the need to carry a separate charger can be a burden.

Almost all mobile phone chargers require an external power source, such as a power outlet, when charging a mobile phone. The need to find the external power source can be disadvantageous on most occasions. The present invention addresses the issue by providing an external battery that can be utilized as a replacement battery for the mobile phone. As a result, the user is allowed to charge the mobile phone whenever the need arises and not when the user finds a charging port.

The objective of the present invention is to address the aforementioned issues. More specifically, the present invention introduces an apparatus that can be used to charge a mobile phone and which is also wearable. The effective design of the present invention allows the user to conveniently carry the apparatus. Since the present invention is designed to be wearable as a necklace, a belt, or other comparable accessory, the charging apparatus requires no additional storage.

### BRIEF DESCRIPTION OF THE DRAWINGS

FIG. 1 is a perspective view of the present invention, wherein the set of charging prongs and the cable output port is in a closed configuration and the rechargeable battery and the charging circuit is represented in dotted lines.

FIG. 2A is a perspective view of the present invention, wherein the set of charging prongs and the cable output port is in an open configuration and the rechargeable battery and the charging circuit is represented in dotted lines.

FIG. 2B is a perspective view of the charging unit illustrating the cable input port and the cable output port, wherein the rechargeable battery and the charging circuit is represented in dotted lines.

FIG. 3 is a bottom perspective view of the present invention illustrating the solar panel.

FIG. 4 is a top view of the present invention, wherein the first end and the second end are attached to each other.

FIG. 5 is another top view of the present invention, wherein the first end and the second end are attached to a memory stick.

FIG. 6 is perspective view of the external covering.

FIG. 7 is a top view of the present invention, wherein the first end is positioned into the cable input port.

FIG. 8 is a perspective view illustrating a different embodiment of the external covering.

FIG. 9 is a block diagram illustrating the electronic connections of the present invention.

### DETAIL DESCRIPTIONS OF THE INVENTION

All illustrations of the drawings are for the purpose of describing selected versions of the present invention and are not intended to limit the scope of the present invention.

The present invention introduces a wearable device that can be used for charging a mobile device. By utilizing the present invention, the need to carry a mobile phone charger, which usually requires additional space is eliminated. Moreover, the effective design of the present invention allows the user to utilize the present invention in any preferred configuration. As an example, the present invention can be worn as a necklace in one instance. In another instance, the present invention can be worn with a belt with minimum visibility.

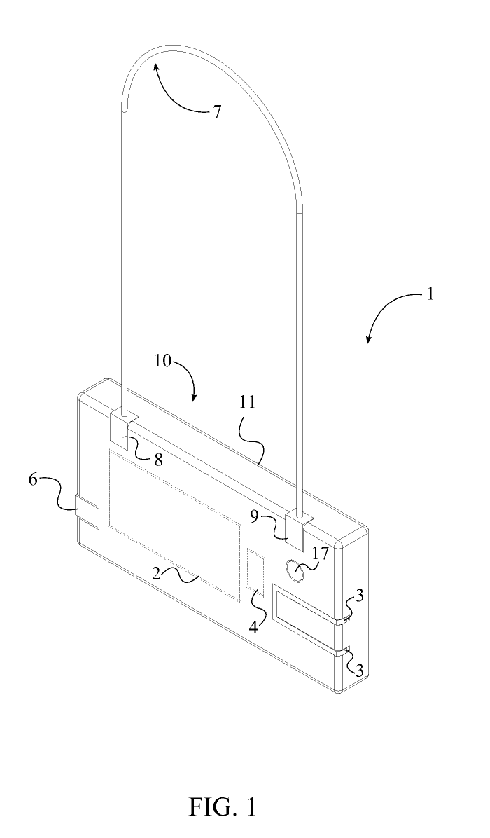

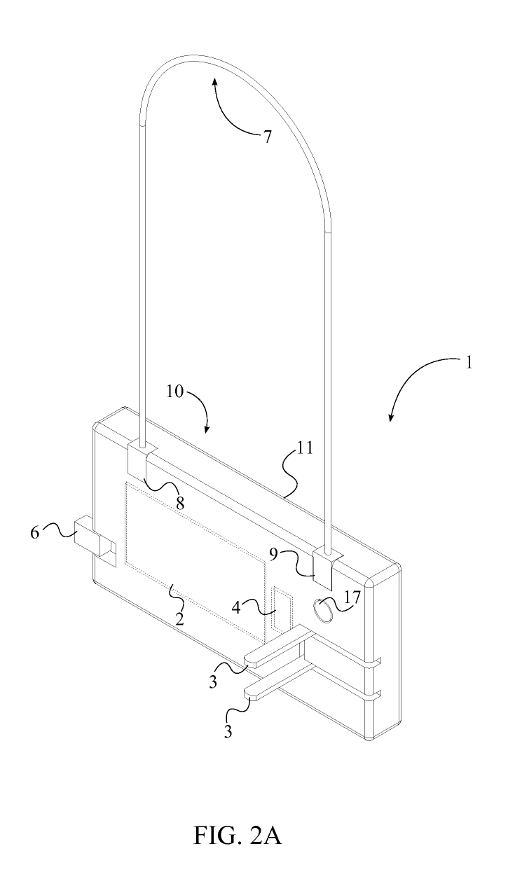

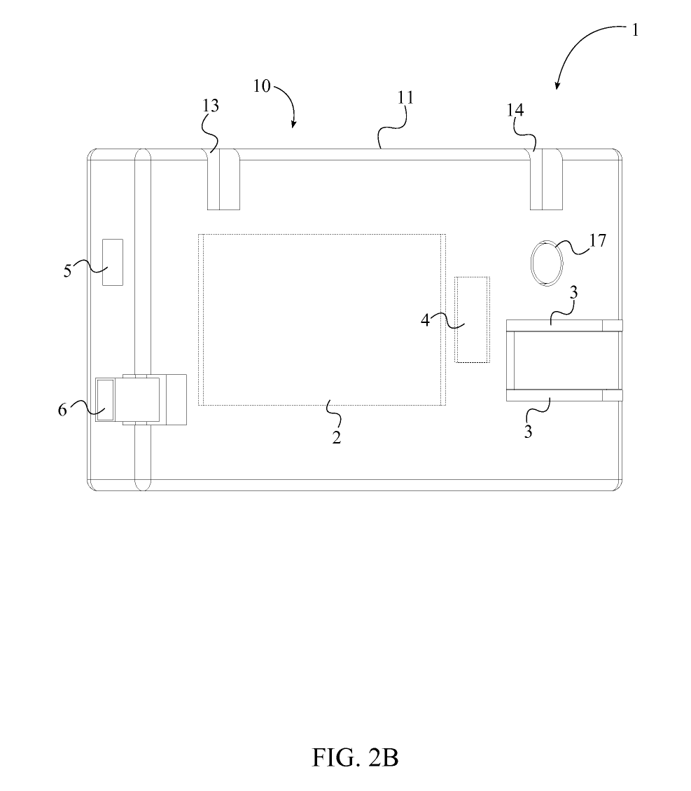

As illustrated in FIGS. 1-2B, the present invention comprises a charging unit 1, a connectivity cable 7, and a casing 10. The connectivity cable 7 is used to transfer power from the charging unit 1 to a mobile phone. In the preferred embodiment of the present invention, the connectivity cable 7 is a universal serial bus (USB) cable. However, the connectivity cable 7 can be any other functional cable in other embodiments of the present invention. The charging unit 1 comprises a rechargeable battery 2, a charging circuit 4, a set of charging prongs 3, a cable input port 5, and a cable output port 6. The rechargeable battery 2 stores energy to be used during the charging process. The cable input port 5 is utilized to provide power to the charging unit 1. Similarly, the cable output port 6 is utilized to transfer power out of the charging unit 1. The charging circuit 4 is utilized for alternating current (AC) to direct current (DC) conversions which is essential when charging a mobile phone battery. The charging circuit 4 also controls the current flow and other related activities during the mobile phone charging process. Both the charging circuit 4 and the rechargeable battery 2 is enclosed within a main housing 11 of the casing 10. The casing 10 can have different shapes and sizes while not deviating from the overall functionality. Therefore, the aesthetically pleasing appearance of the present invention is not hindered. Even though the charging circuit 4 and the rechargeable battery 2 is enclosed within the main housing 11 in the preferred embodiment of the present invention, the rechargeable battery 2 and the charging circuit 4 can be positioned differently in other embodiments of the present invention such that the overall functionality of the present invention remains unchanged. In order to complete the charging process, the set of charging prongs 3, the cable input port 5, and the cable output port 6 are electronically connected the charging circuit 4. Moreover, the rechargeable battery 2 is electrically connected to the charging circuit 4 in order to complete the charging process. As mentioned above, the present invention is intended to be wearable. In doing so, the connectivity cable 7 is utilized. As an example, if the present invention is worn around the neck, the connectivity cable 7 functions as the necklace portion while the charging unit 1 functions as a medallion. In another instance, if the present invention is worn around the waist along a belt, the connectivity cable 7 is attached to the belt. Additionally, the present invention can be used as a belt alone, such that the charging unit 1 functions as a belt buckle. The length of the connectivity cable 7 can vary such that a wide variety of clients can be catered. To provide user convenience, the connectivity cable 7 is removably attached to the casing 10. Since the charging unit 1 is intended to function as the medallion, it is essential for the set of charging prongs 3 to use a limited amount of space and not interrupt the user when worn around the neck. In order to do so, the set of charging prongs 3 are hingedly connected to the casing 10 as shown in FIG. 2A. The hinged connection allows the set of charging prongs 3 to lie flush against the casing 10 when not in use and be conveniently extended when needed. Similar to the set of charging prongs 3, the cable output port 6 is also hingedly connected to the casing 10 in the preferred embodiment of the present invention. On the other hand, the cable input port 5 is embedded into the casing 10 such that minimum space is required.

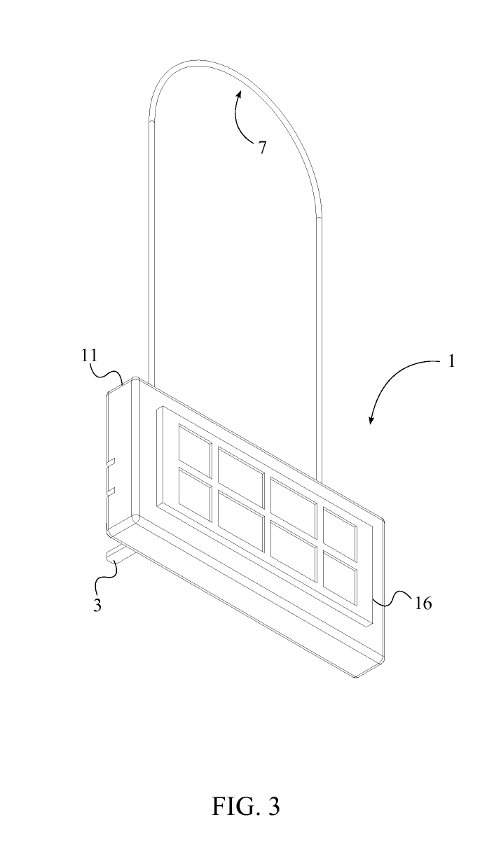

As shown in FIG. 3, the need to always have a power outlet to charge the charging unit 1 has been eliminated by using a solar panel 16 in one embodiment of the present invention. More specifically, the present invention utilizes the solar panel 16 to charge the rechargeable battery 2. The solar panel 16 is adjacently connected to the casing 10 such that the solar panel 16 has maximum exposure. Moreover, the solar panel 16 is electronically connected to the charging circuit 4. Resultantly, the generated power can be efficiently transferred onto the rechargeable battery 2. As illustrated in FIG. 3, the solar panel 16 is positioned opposite the set of charging prongs 3. However, the set of charging prongs 3 and the solar panel 16 can be positioned differently in other embodiments of the present invention.

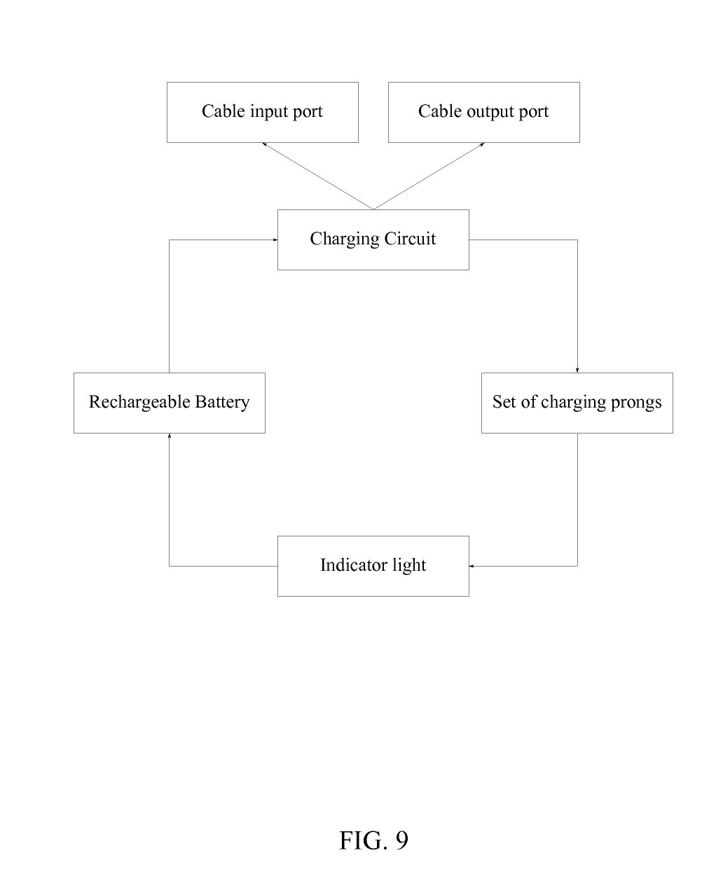

The present invention utilizes an indicator light 17 to notify the user when the present invention is in use. In order to be clearly visible, the indicator light 17 is embedded into the casing 10. In the preferred embodiment of the present invention, the indicator light 17 is positioned adjacent the set of charging prongs 3 such that the user is immediately notified when current starts flowing into the charging unit 1. Moreover, the indicator light 17 is also electronically connected to the charging circuit 4 as illustrated in FIG. 9.

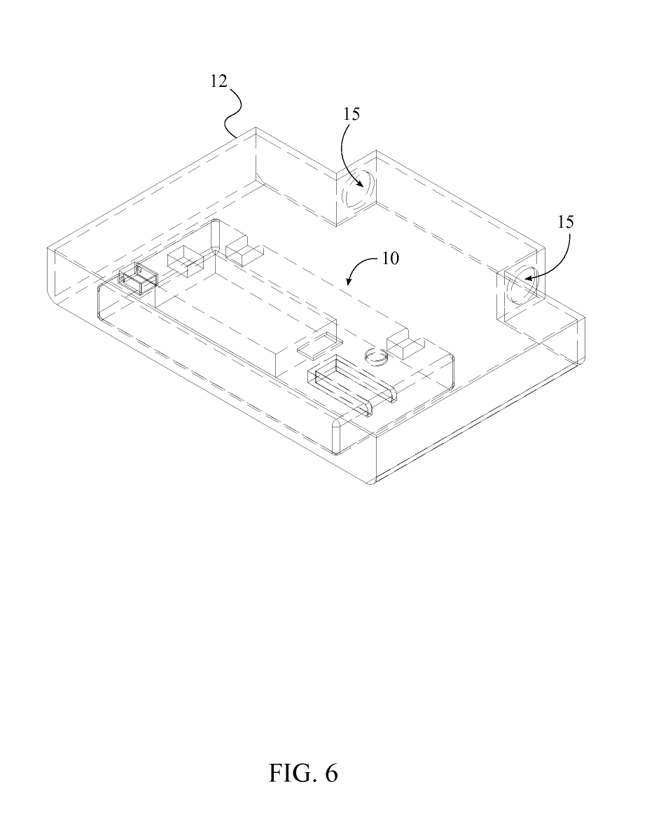

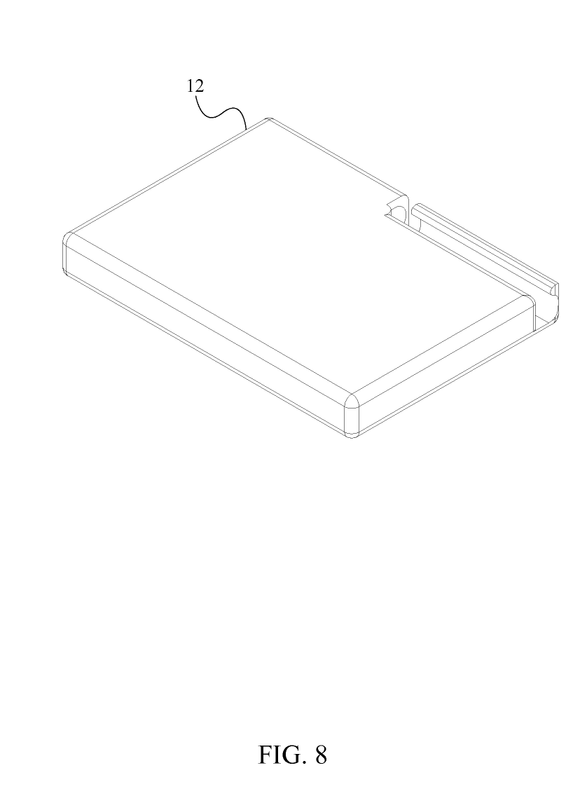

The casing 10 of the present invention further comprises an external covering 12. In the preferred embodiment of the present invention, the external covering 12 is a silicon covering which is waterproof and also lightweight. However, the external covering 12 can change in different embodiments of the present invention as illustrated in FIG. 8. When the external covering 12 is being utilized, the casing 10 is positioned within the external covering 12 as shown in FIG. 6. Therefore, attaching the connectivity cable 7 to the casing 10 can be inconvenient. In order to address the issue, the external covering 12 comprises a cable receiving opening 15. The connectivity cable 7 is attached to the external covering 12 by inserting the connectivity cable 7 through the cable receiving opening 15. More specifically, the connectivity cable 7 traverses through the cable receiving opening 15. In order to provide user convenience, the external covering 12 can contain a fastening mechanism such that the user can conveniently position the casing 10 within the external covering 12 or remove the casing 10 from the external covering 12.

As previously mentioned, the casing 10 in its entirety is positioned within the external covering 12. However, in another embodiment of the present invention, the rechargeable battery 2 or an additional battery specific for the mobile phone of the user can be positioned within the external covering 12 by itself. As a result, the user can replace the battery of the mobile phone when the need for additional power source arises. In other words, the user is allowed to charge the mobile phone instantly without using a power outlet.

As discussed earlier, the connectivity cable 7 is removably attached to the casing 10. In doing so, a first end 8 and a second end 9 of the connectivity cable 7 are utilized. More specifically, the first end 8 is removably attached to a first clip 13 of the casing 10. Likewise, the second end 9 is removably attached to a second clip 14 of the casing 10 as shown in FIG. 1. The first clip 13 and the second clip 14 are designed to protrude into the casing 10 as seen in FIG. 2B. Therefore, when the first end 8 and the second end 9 are attached to the casing 10, the first end 8 and the second end 9 lie flush against an outer surface of the casing 10. Therefore, the first end 8 and the second end 9 do not cause any discomfort to the user when the charging unit 1 is used as the medallion.

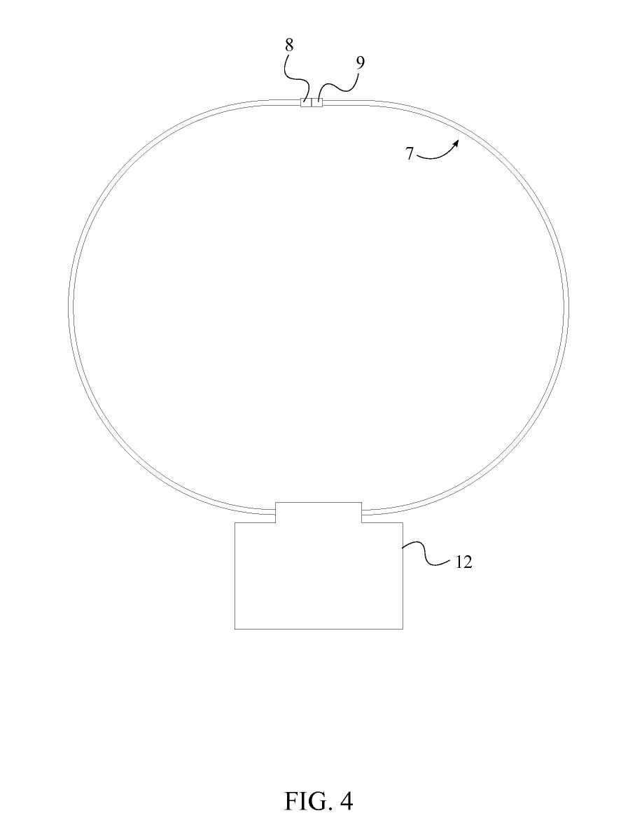

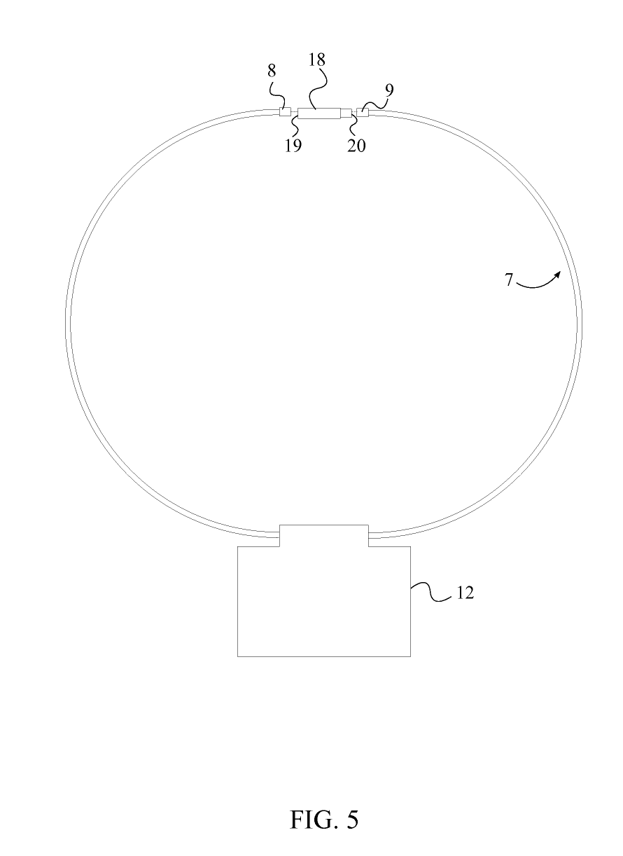

When the external covering 12 is utilized, the first end 8 and the second end 9 can be attached differently. As shown in FIG. 4, the first end 8 and the second end 9 are attached to each other after the cable traverses through the cable receiving opening 15. In another embodiment of the present invention, a memory stick 18 can also be used to attach the first end 8 and the second end 9 as illustrated in FIG. 5. In doing so, the first end 8 is attached to a first terminal end 19 of the memory stick 18. Similarly, the second end 9 is attached to a second terminal end 20 of the memory stick 18. As a result of using the memory stick 18, the user is provided with additional storage which can be beneficial under different circumstances.

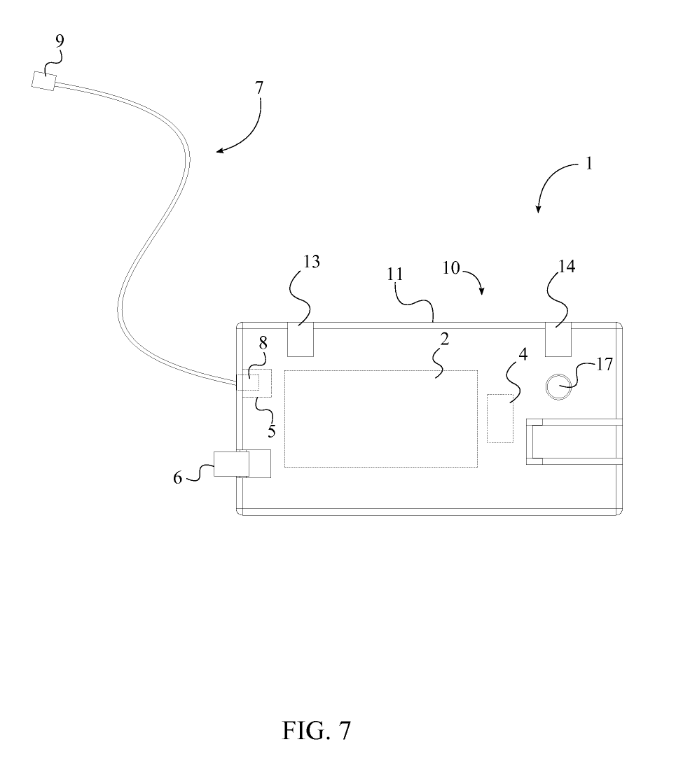

When utilizing the present invention, the following general process flow can be followed. As an example, we shall consider the embodiment of the present invention wherein the first end 8 and the second end 9 is removably attached to the casing 10. When the user intends on utilizing the present invention, the user initially detaches the first end 8 and the second end 9 from the first clip 13 and the second clip 14 respectively. The availability of the cable input port 5 and the cable output port 6 allows the user to utilize the present invention in multiple configurations. As an example, the cable input port 5 can be utilized along with the connectivity cable 7 to charge the rechargeable battery 2 through an external power source which is different from a power outlet. The external power source can be a computer or other comparable source. In doing so, the first end 8 is inserted into the cable input port 5 such that the first end 8 is electronically connected and positioned into the cable input port 5 as shown in FIG. 7. In another instance, when the present invention is used to charge the mobile phone, the second end 9 is inserted into the cable output port 6 and the first end 8 is connected to the mobile phone of the user. Resultantly, the second end 9 is electronically connected and positioned into the cable output port 6. If the user intends on charging the rechargeable battery 2 through a power outlet, the set of charging prongs 3 is utilized. When the need occurs to transport the present invention, the user attaches the first end 8 to the first clip 13 and the second end 9 to the second clip 14. The resultant position of the connectivity cable 7 and the charging unit 1 allows the user to wear the present invention as a necklace such that the charging unit 1 functions as a medallion. When a connectivity cable 7 with considerable length is used, the present invention can be used along with a belt or as a belt. In such instances, the charging unit 1 functions as a belt buckle.

When the first end 8 and the second end 9 are removably attached to each other, the first end 8 is detached from the second end 9. Next, the connectivity cable 7 is separated by pulling the connectivity cable 7 out of the cable receiving opening 15. When separated, the connectivity cable 7 can be used according to user preference. By utilizing the present invention the user is guaranteed to have a mobile phone charger at all times. Moreover, the present invention eliminates the need to find a power outlet when the mobile phone battery needs to be charged.

Although the invention has been explained in relation to its preferred embodiment, it is to be understood that many other possible modifications and variations can be made without departing from the spirit and scope of the invention as hereinafter claimed.

What is claimed is:

1. A wearable charging apparatus comprises:
a charging unit;
a connectivity cable;
a casing comprises a main housing;
the charging unit comprises a rechargeable battery, a charging circuit, a set of charging prongs, a cable output port, and a cable input port;
the charging circuit and the rechargeable battery being enclosed within the main housing;
the set of charging prongs, the cable input port, and the cable output port being electronically connected to the charging circuit;
the rechargeable battery being electrically connected to the charging circuit;
the connectivity cable comprises a first end and a second end;
the connectivity cable being removably attached to the casing;
the set of charging prongs being hingedly connected to the casing;
the cable input port and being embedded into the casing; and
the cable output port being hingedly connected to the casing.

2. The wearable charging apparatus as claimed in claim 1 comprises:
a solar panel;
the solar panel being adjacently connected to the casing; and
the solar panel being electronically connected to the charging circuit.

3. The wearable charging apparatus as claimed in claim 2, wherein the solar panel is positioned opposite the set of charging prongs.

4. The wearable charging apparatus as claimed in claim 1 comprises:
an indicator light;
the indicator light being embedded into the casing;
the indicator light being electronically connected to the charging circuit; and
the indicator light being positioned adjacent the set of charging prongs.

5. The wearable charging apparatus as claimed in claim 1 comprises:
the casing further comprises an external covering;
the external covering comprises a cable receiving opening;
the casing being positioned within the external covering; and
the connectivity cable traversing through the cable receiving opening.

6. The wearable charging apparatus as claimed in claim 1 comprises:
the casing further comprises a first clip and a second clip;
the first end being removably attached to the first clip; and
the second end being removably attached to the second clip.

7. The wearable charging apparatus as claimed in claim 1, wherein the first end and the second end is removably attached to each other.

8. The wearable charging apparatus as claimed in claim 1 comprises:
a memory stick;
the memory stick comprises a first terminal end and a second terminal end;
the first end being attached to the first terminal end; and
the second end being attached to the second terminal end.

9. The wearable charging apparatus as claimed in claim 1, wherein the first end being electronically connected and positioned into the cable input port.

10. A wearable charging apparatus comprises:
a charging unit;
a connectivity cable;
a casing comprises a main housing;
a solar panel;
the charging unit comprises a rechargeable battery, a charging circuit, a set of charging prongs, a cable output port, and a cable input port;
the charging circuit and the rechargeable battery being enclosed within the main housing;
the set of charging prongs, the cable input port, and the cable output port being electronically connected to the charging circuit;
the rechargeable battery being electrically connected to the charging circuit;
the connectivity cable comprises a first end and a second end;
the connectivity cable being removably attached to the casing;
the set of charging prongs being hingedly connected to the casing;
the cable input port and being embedded into the casing;
the cable output port being hingedly connected to the casing;
the solar panel being adjacently connected to the casing; and
the solar panel being electronically connected to the charging circuit.

11. The wearable charging apparatus as claimed in claim 10, wherein the solar panel is positioned opposite the set of charging prongs.

12. The wearable charging apparatus as claimed in claim 10 comprises:
an indicator light;
the indicator light being embedded into the casing;
the indicator light being electronically connected to the charging circuit; and
the indicator light being positioned adjacent the set of charging prongs.

13. The wearable charging apparatus as claimed in claim 10 comprises:
the casing further comprises an external covering;
the external covering comprises a cable receiving opening;
the casing being positioned within the external covering; and
the connectivity cable traversing through the cable receiving opening.

14. The wearable charging apparatus as claimed in claim 10 comprises:
the casing further comprises a first clip and a second clip;
the first end being removably attached to the first clip; and
the second end being removably attached to the second clip.

15. The wearable charging apparatus as claimed in claim 10, wherein the first end and the second end is removably attached to each other.

16. The wearable charging apparatus as claimed in claim 10 comprises:
a memory stick;
the memory stick comprises a first terminal end and a second terminal end;
the first end being attached to the first terminal end; and
the second end being attached to the second terminal end.

17. The wearable charging apparatus as claimed in claim 10, wherein the first end being electronically connected and positioned into the cable input port.
